(19) United States
(12) Patent Application Publication
(10) Pub. No.: US 2005/0136987 A1
(43) Pub. Date: Jun. 23, 2005

(54) Tactile communication system

(75) Inventors: Randolph Michael Forlenza, Austin, TX (US); Herman Rodriguez, Austin, TX (US)

Correspondence Address: Robert V. Wilder, 4235 Kingsburg Drive, Round Rock, TX, 78681, US

(73) Assignee: International Business Machines Corporation, Armonk, NY (US)

(21) Appl. No.: 10/739,437

(22) Filed: Dec. 18, 2003

(51) Int. Cl. H04M 1/00

(52) U.S. Cl. 455/567; 455/550.1

(57) ABSTRACT

A method and implementing system are provided in which a telephone unit or other telecommunications unit is programmed to transmit codes to a receiving telecommunications unit which has a vibration capability. Individuals are enabled to transmit response signals which are effective to cause predetermined vibration patterns in the receiving unit of a hearing-impaired individual. Such vibration patterns are predefined to represent predetermined answers. The vibration patterns are readily felt and interpreted by hearing-impaired and other individuals.

### FIELD OF THE INVENTION

The present invention relates generally to information processing and more particularly to a methodology and implementation for tactile messaging systems.

### BACKGROUND OF THE INVENTION

Advancing telephone and other wireless technologies have resulted in many new wireless devices and telephone call-processing techniques. Hearing-impaired individuals benefit from text messaging telecommunications devices. However, many hearing-impaired individuals do not consider the expense of such a device to be worth the recurring monthly costs which arrive regardless of the extent of monthly usage. Further, not all telecommunications devices have a text messaging capability. For example, hard wire home phones, public pay phones, and less expensive and older cellular phones do not have text messaging capabilities. Moreover, not all users are enrolled for text messaging services and there are carriers that do not offer text service.

Hearing-impaired users often utilize cellular and other telecommunications devices to call third parties. They can easily speak to the third party but may find it extremely difficult to correctly interpret the third party responses via the telecommunication device's speaker. Hearing-impaired users can find it extremely disconcerting to conduct even brief and simple telephone communications via the device's speaker. The problem is that background noise, device white noise, poor quality speaker devices, and sending parties with accents, mumbling, speech impediments, etc. can make it almost impossible for hearing-impaired users to determine the response even to questions soliciting only a simple YES/NO response. Consequently, there are many situations where a hearing-impaired user cannot communicate under even simple YES/NO situations and this is a very serious aggravation to hearing-impaired users in a variety of situations.

It can also be difficult for a hearing-impaired user to determine if a third party has answered a call and, if so, whether a person or a device (FAX, automated phone system) has responded. In the latter scenario, the hearing-impaired user has no way of determining if a message has been received by a party that can precipitate action.

Thus, there is a need for an improved method and system for facilitating communication with hearing-impaired persons using communication devices including but not limited to wireless devices.

### SUMMARY OF THE INVENTION

A method and implementing system are provided in which a telephone unit or other telecommunications unit is programmed to transmit codes to a receiving telecommunications unit which has a vibration capability. Individuals are enabled to transmit signals which are effective to cause predetermined vibration patterns in the receiving unit of a hearing-impaired individual. Such vibration patterns are predefined to represent predetermined answers. The vibration patterns are readily felt and interpreted by hearing-impaired and other individuals.

### BRIEF DESCRIPTION OF THE DRAWINGS

A better understanding of the present invention can be obtained when the following detailed description of a preferred embodiment is considered in conjunction with the following drawings, in which:

FIG. 1 is an illustration of a wireless environment in which the present invention may be implemented;

FIG. 2 is an exemplary block diagram of several of the major components of a communication device in which the present invention may be implemented;

FIG. 3 is a flow chart illustrating a partial exemplary operational sequence occurring when a hearing-impaired individual is placing a call to a receiving party;

FIG. 4 is a flow chart illustrating a partial exemplary operational sequence occurring when a call is received from a hearing-impaired individual; and

FIG. 5 is a flow chart illustrating a partial exemplary operational sequence occurring when a call is received by a hearing-impaired individual;

### DETAILED DESCRIPTION

The various methods discussed herein may be implemented between communications devices which are connected through a communications network. Such communications devices include but are not limited to cell and other wireless telephones, pagers, personal digital assistants (PDAs), and other hand-held devices capable of transmitting and receiving information. Such communications networks may or may not include one or more intermediate telecom application servers. In general, an implementing server and/or wireless device may include a plurality of processors in a multi-bus system and may be one of a network of similar systems. To the extent that the present invention is composed of electronic components and circuits which are generally known to those skilled in the art, circuit details beyond those shown are not specified to any greater extent than that considered necessary as illustrated, for the understanding and appreciation of the underlying concepts of the present invention and in order not to obfuscate or distract from the teachings of the present invention.

In an exemplary embodiment, a receiving telecommunications unit is fitted with software or firmware that can be programmed to interpret predefined received key sequences to indicate a vibration pattern which is effected by the receiver's vibration circuitry. The user (or service provider or device provider) programs the receiving telecommunications unit to respond to the predefined key sequences or a to represent an event during the telephone connection in a prescribed manner such that a unique set of vibrations is emitted for each unique key sequence. A standard is created for common telecommunications events, such as: a) call answered by person; b)call answered by machine; c) line busy; etc. When incoming calls are received by a device, that device automatically (or person manually) responds with the appropriate key sequence (as in standards above), and the receiving telecommunications unit searches all incoming transmissions for such key sequences or events. Upon receiving and isolating a vibration key sequence, the receiving unit emits a sequence of vibrations according to its pre-programmed definitions. Hearing-impaired users interpret the response based on the vibration pattern, and, if desired, the hearing-impaired user verifies the received response by asking for confirmation via simple YES/NO queries and/or a repeat of the last emitted vibration pattern. The present invention is equally applicable in both digital and analog environments for all users and is not limited to have application only to hearing-impaired individuals. For example, the present invention is considered to be quite useful to individuals who are calling from particularly noisy environments as a main communication device or as a verbal confirmation technique.

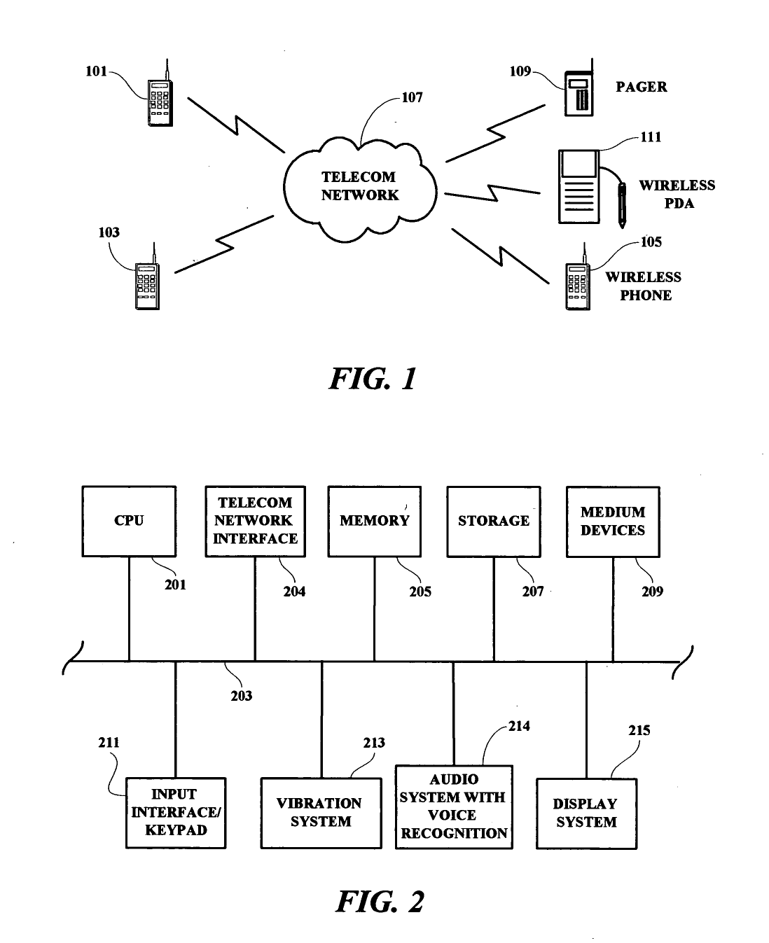

In FIG. 1, there is shown an illustration of a telephone environment in which the present invention may be implemented. As shown, a telecom network 107 is used to couple a variety of telecommunication devices such as cell phones 101, 103, and 105 as well as a pager 109 and/or a wireless personal digital assistant or PDA 111. In implementing the present invention, any of the above and other devices is designed to include a vibration function which is selectively operable in response to received signals to effect a vibration or series of vibrations to occur within the communication device. The vibration function may be implemented, for example, with an axially offset counterweight which is driven by a motor to cause a vibrating sensation. Other techniques may also be implemented to create the vibration response in a communication device.

In FIG. 2, several of the major electronic subsystems and components within any of the applicable communication devices are illustrated. As shown, a processor 201 is coupled to a system bus 203. It is noted that the processing methodology disclosed herein will apply to many different bus and/or network configurations although only one example is illustrated. A memory subsystem 205, a storage device 207 and selected medium devices 209 are also shown connected to the system bus 203. The information processing circuitry illustrated in FIG. 2 is arranged to establish a communication link and initiate communication with the user devices as shown in FIG. 1. A server device (not shown) may also be connected through a network interface connection 204 to any appropriate network 107, including the Internet, from which incoming calls for the user devices are initially received and transferred. The exemplary communication device also includes an input interface 211, e.g. a keypad, to enable a user to enter key inputs, and a vibration system 213 capable of causing the communication device to vibrate in response to predetermined signals. Also included is an audio system which includes voice recognition capabilities 214, and a video or display system 215 for display of various menus and messages and other information related to various aspects of a telecom application being executed.

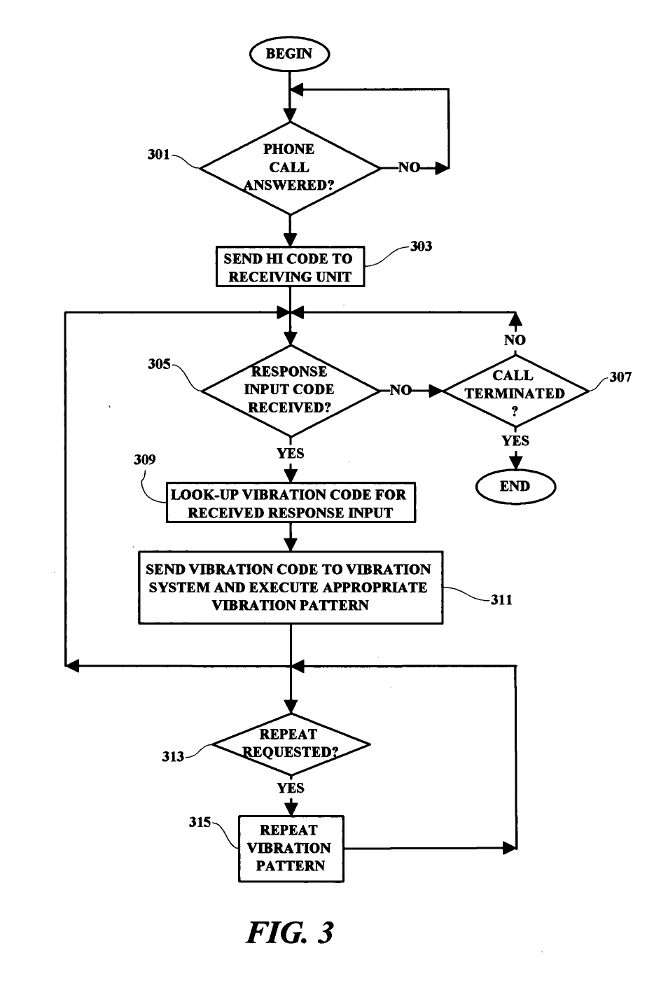

An exemplary outgoing call methodology is illustrated in the flow chart of FIG. 3. As shown, when a call is placed by a hearing-impaired person for example, the system first determines when the call is answered 301 and then transmits a hearing-impaired (“HI”) code 303 to the called or receiving unit. The HI code may be as simple as a single bit of information or it may be as detailed as an executable program which is executable on the receiver's communication device to advise the receiver that the calling party is hearing-impaired and desires the receiving party to respond in a particular manner such as by entering key inputs rather than by speaking. The calling hearing-impaired party may also verbally advise the receiving party with regard to the preferred protocol. Answers to questions posed by the hearing-impaired caller may be input by a called party according to a predetermined methodology. For example, a called party may indicate a “Yes” by entering a “Y” and a “No” by entering an “N” on the device keypad. Other coded responses may also be used such as a “star” or “asterisk” input (“*”) for a “Yes” answer and a “pound sign” (“#”) for a “No” answer. This protocol may also be accomplished with a programmed display or menu on the receiver's device. In another embodiment, the HI code is interpreted by the receiving party's device to access a database which is stored in memory within the receiving party's device and is effective to cause an appropriate display to appear on the display of the receiving party's communication device to indicate which keys to push for certain predetermined answers. An appropriate recording may also be played to the receiving party.

After the HI code is sent to the receiving party 303, the hearing-impaired party speaks to the receiving party and the communication device being used by the calling, hearing-impaired party continually checks 305 to determine when a response input code is received from the called party. This might occur for example when the caller asks a question and the called party answers by entering a “Yes” response code (e.g. a “Y” or “*”) or a “No” code (e.g. a “N” or “#”) into the keypad of a cell phone for example. The called party may also simply speak the response (e.g. “Yes” or “No”) and the voice recognition system 214 will translate the voice input into a corresponding response input code which is then sent to the communication device being used by the hearing-impaired party to effect a vibration response at the device of the hearing-impaired party. The process may be ended at any time when the call is terminated 307 by a hang-up for example. When a response input code is received by the calling, hearing-impaired party, the communication device in the present example is operable to look-up 309 the vibration code for the received response code, and send the appropriate vibration code to the vibration system of the calling unit to execute the appropriate vibration response pattern 311.

For example, if a “Yes” code is detected as being received by the hearing party, then, a series of three short vibration periods would be caused at the hearing-impaired party's device. The hearing party would feel the three short vibration periods and know that the called party has affirmatively answered a question with a “Yes” answer or affirmed what the hearing-impaired caller has said to the called party. In the present example, a long slow vibration period would signify a “No” response from the called party. The hearing-impaired party will know what the called party is saying by interpreting the vibrations which are occurring at the hearing party's phone and felt by the hearing-impaired individual.

As shown in FIG. 3, a methodology is also provided by which a hearing-impaired party may request 313 a repeat of the most recently applied vibration pattern. After being applied, the vibration patterns are stored in memory at the device of the hearing-impaired party, and upon request, the vibration pattern of the most recent response may be repeated 315 to confirm a received answer to the hearing-impaired party. Alternatively, the request for a repeat may be forwarded to the receiving party's device and the last response code may be returned from memory of the receiving party's device. As illustrated, the vibration response function is repeated until the call is terminated 307.

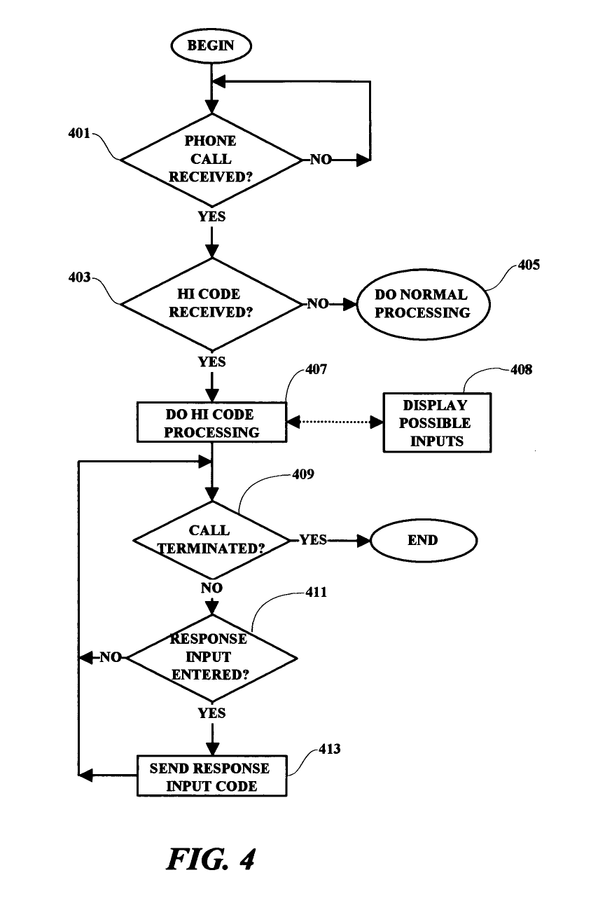

In FIG. 4, the processing which occurs at the called party's device is illustrated. As shown, when a call is received 401, a check is made to determine if hearing-impaired (HI) programming has been received 403. If HI code is not received after the call is answered, then normal call processing 405 is accomplished. If, however, HI code is received 403, then HI code processing is accomplished 407. As hereinbefore note, the HI code may be merely a bit in a string sent from a sending device which is operable to fetch and execute code resident in the called party's device, or the HI code may be more extensive code transferred from the calling party's device and executed at the receiving party's device. In either case, the HI code will effect a vibration mode in which the called party is notified that the calling party is hearing-impaired and that answers to questions should be entered by pushing predetermined keys in the receiving party's phone or other receiving device which, in turn, will result in perceptible vibrations or vibration patterns at the hearing-impaired party's phone or other device. In one example, possible inputs are displayed 408 so that the called party is informed of which keys to push in order to communicate different messages such as “Yes” or “No”, etc. The processing monitors the line to detect when a response input is entered 411 on the called party's keypad or other input device. When entered, the response code is sent 413 to the calling party's device and the monitoring process continues. The processing is ended at any time the call is terminated 409 such as when one of the parties hangs-up.

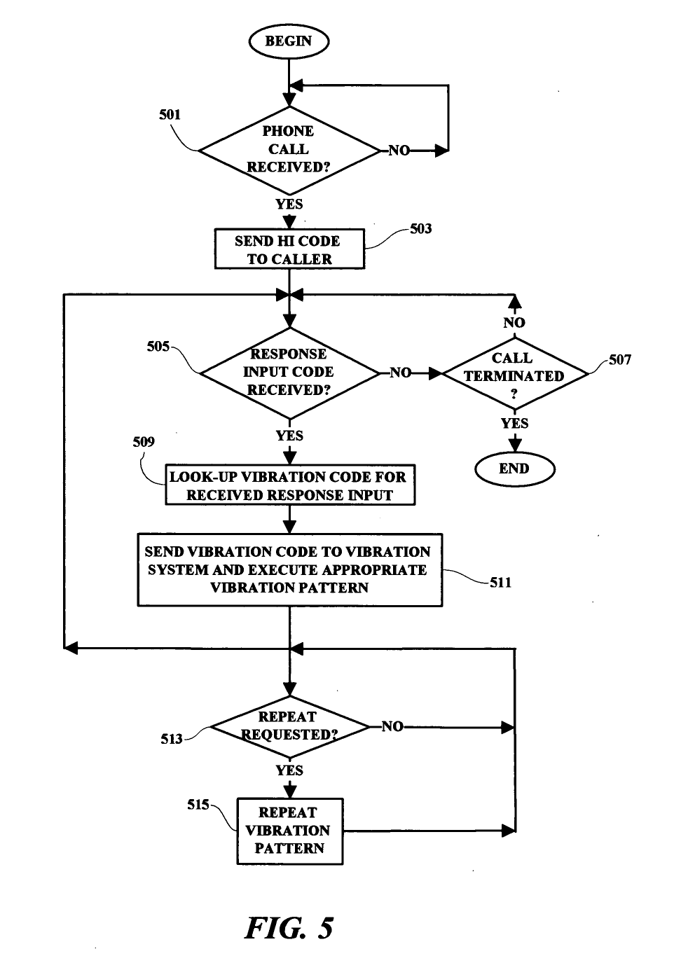

In FIG. 5, the processing which occurs at a hearing-impaired party's phone when called by another device. When a call is received 501, the HI code is sent 503 to the caller to communicate to the caller that the called party is hearing-impaired and that keypad responses are requested. Thereafter, when response input codes are received 505 from the calling party, a database in the called party's memory is accessed 509 and the vibration code corresponding to the received response input by the calling party is determined. For example, when a “Y” signal is received, the called hearing-impaired party's device will access an internal database to determine that a “Y” corresponds to three short vibration bursts and vibration signals are sent 511 to the vibration system 213 of the called party's device to effect three short vibration bursts on the hearing-impaired party's phone. The hearing-impaired party will then know that the calling party has responded in a positive manner to a comment or question posed by the hearing-impaired individual. As hereinbefore noted, the called party may then request a repeat 513 of the last vibration pattern and have the vibration repeated 515. The processing continues to monitor for response input codes 505 and is ended at any time one of the parties hangs-up 507.

In practice, the vibration patterns, and what each pattern stands for, is predetermined and stored in one or both communication devices used by the communicating parties. The patterns may be any recognizable vibrating pattern and different patterns may stand for any known possible or expected response to a hearing-impaired party's question or statement or to other situations that may be encountered. For example, different vibration patterns may be related to different answers including but not limited to common responses such as “Good-bye”, Fax Machine answer, Answering Machine answer, etc. With fax machine answers for example, a hearing-impaired caller may not be able to hear the distinctive frequencies emitted by a fax machine answer. With the present invention, however, a distinctive vibration pattern is set-up in the vibration converter database such that when the system detects that a fax machine has answered a call from a hearing-impaired individual, a predetermined vibration pattern is effected at the phone of the hearing-impaired individual in order to communicate the situation to the hearing-impaired caller.

There are unlimited other possible sequences and codes. Sequences may include bursts of varying durations of high frequency and/or low frequency pulses. For example, users speaking to their spouse could originate user-programmable private codes to indicate “home”, “shopping”, “car”, “school”, “kids”, etc. each of which would be designated either by the length of the resulting vibrations and/or the pattern of the vibrations (e.g. short/pause/long/pause/long/pause/short) to signify to a hearing-impaired individual that a called spouse is picking up the children from school. Other standards and/or programmable codes can be created that cause one type of response when a person answers a call and distinguish that situation from when a machine answers.

Several additional possible exemplary usage scenarios are discussed below. Sender “S” types Key Sequences to convey a vibrating message to (hearing-impaired) receiver “R”. R feels the vibration code on his or her phone and dials the number associated with S and someone answers the call.

The following actions assume S answers the phone R (hearing-impaired) verbally asks if he is speaking to S. S types in “Y” on phone keypad. R's phone receives “Y” sequence and translates/maps the “Y” sequence into a pattern of vibrations. R's phone emits, for example, three short vibration bursts. R senses the vibrations of the device in his hand R understands that he is speaking with S.

The following actions assume X answers the phone but S is in residence. If the user is NOT S, but understands the codes, S types in “N” for “NO” which R understands to mean that S did not answer. R verbally asks if S is available. X types “Y” for “YES”. R verbally asks if he can speak with S. X types “Y” for “YES” if S is available or “N” for “NO” is S is not available. If X responds with NO, R verbally asks if he can leave a message to which X responds “Y” or “N”. R then leaves a message. R says that R is hanging up if X has taken the message. X responds with “Y” and then enters input code for “Good-bye” and the call is terminated.

In another example, R (hearing-impaired) misdials S's residence number and gets a FAX machine by mistake. The fax machine automatically sounds the fax code which is interpreted by R's vibration database and results in the generation of continuing short vibration pulses. R feels the vibrations and knows he has misdialed and called a FAX machine by mistake. R hangs up and tries again.

In another scenario, R dials S's residence and gets an answering machine. The answering machine issues a signal indicative of the fact that it is an answering machine (in addition to a pre-recorded message). R's handset receives the answering machine code and translates the code to a vibration pattern. R feels the vibration pattern and knows that R has contacted an answering machine and that a recorded message is playing. When the recorded message plays out, the answering machine issues another code which is interpreted by R's device to effect a predetermined vibration pattern on R's phone. R then knows that the recorded message has played out and ended. R then leaves a message and hangs-up.

In another scenario, R dials S's wireless phone and gets S's voicemail system instead. The voicemail system receives a HI code from R's phone. R's handset receives signal indicative of the fact that it is a voicemail system. R's device receives a code and translates the code to a vibration pattern. R feels the vibration pattern and knows that R has contacted a voicemail system. Since there is no need to play out a prompt message, the voicemail system issues a code which is interpreted by R's device to effect a predetermined vibration pattern on R's phone. R then knows that R can leave a message, then R leaves a message and hangs-up.

In another scenario, working from a displayed telephone directory, R associates a telephone directory entry on R's phone with specific entries on a list of directory entries on R's phone. The directory entries and associated vibration patterns are stored on R's phone such that different directory entries can be associated with vibration patterns corresponding to various targets, including S. As R (hearing-impaired) scrolls a displayed telephone directory and selects a directory listing to be dialed, the associated codes describing the selected vibration patterns are transmitted to S's phone when the respondent answers. This permits R to place a call to by simply selecting the directory entry of S and dialing. It also sets S's telecommunication device to the correct vibration pattern without any action on S's part. S will respond to R's call with key sequence's that create vibrations on R's phone in the previously mutually agreed vibration protocol.

In another scenario, working from a displayed telephone directory, S associates a sets of vibration patterns on S's phone with specific entries on a list of directory entries on S's phone. The directory entries and vibrations patterns are stored on S's phone such that directory entries can be associated with a vibration pattern corresponding to various targets, including R. As S scrolls a displayed telephone directory and selects a directory listing to be dialed, the associated codes describing the selected vibration patterns become the active vibration set for S's phone. This permits S to place a call by simply selecting the directory entry of R and dialing. It allows S to maintain differing vibration patterns for different respondents. It also sets S's phone to the correct vibration pattern without any action on S's part. S will respond to R's verbal responses with key sequence's that creates vibrations on R's phone in the previously mutually agreed vibration protocol.

The method and apparatus of the present invention has been described in connection with a preferred embodiment as disclosed herein. The disclosed methodology may be implemented in a wide range of sequences, menus and screen designs to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented solely in program code and executed to achieve the beneficial results as described herein. Accordingly, the present invention is not intended to be limited to the specific form set forth herein, but on the contrary, it is intended to cover such alternatives, modifications, and equivalents, as can be reasonably included within the spirit and scope of the invention.

1. A method for using tactile capabilities to communicate information from a first party using a first communication device to a second party using a second communication device, said method comprising:
establishing a telecommunication connection between said first communication device and said second communication device;
providing input means by which said first party is enabled to selectively enter selected input to said first communication device after said establishing of said telecommunication connection;
transmitting information signals representative of said selected input from said first communication device to said second communication device;
receiving said information signals by said second communication device; and
enabling said second communication device to commence a vibration of said second communication device in response to said received information signals.

2. The method as set forth in claim 1 wherein said vibration comprises one of a plurality of predetermined vibration patterns, said predetermined vibration patterns being related to corresponding predetermined messages.

3. The method as set forth in claim 1 wherein said input means comprises a non-verbal input means.

4. The method as set forth in claim 3 wherein said non-verbal input means comprises a keypad input device.

5. The method as set forth in claim 1 wherein said input means comprises a voice recognition means whereby voice input to said first communication device effects a corresponding vibration of said second communication device.

6. The method as set forth in claim 1 wherein at least one of said first and second communication devices comprises a wireless communication device.

7. The method as set forth in claim 6 wherein said one of said first and second communication devices comprises a cell phone.

8. The method as set forth in claim 6 wherein said one of said first and second communication devices comprises a personal digital assistant device.

9. The method as set forth in claim 1 wherein said selected input is presented on a display screen of said first communication device.

10. A storage medium including machine readable coded indicia, said storage medium being selectively coupled to a reading device, said reading device being selectively coupled to processing circuitry within a communication device, said reading device being selectively operable to read said machine readable coded indicia and provide program signals representative thereof, said program signals being selectively operable for using tactile capabilities to communicate information from a first party using a first communication device to a second party using a second communication device, said program signals being selectively operable for:
establishing a telecommunication connection between said first communication device and said second communication device;
providing input means by which said first party is enabled to selectively enter selected input to said first communication device after said establishing of said telecommunication connection;
transmitting information signals representative of said selected input from said first communication device to said second communication device;
receiving said information signals by said second communication device; and
enabling said second communication device to commence a vibration of said second communication device in response to said received information signals.

11. The medium as set forth in claim 10 wherein said vibration comprises one of a plurality of predetermined vibration patterns, said predetermined vibration patterns being related to corresponding predetermined messages.

12. The medium as set forth in claim 10 wherein said input means comprises a non-verbal input means.

13. The medium as set forth in claim 12 wherein said non-verbal input means comprises a keypad input device.

14. The medium as set forth in claim 10 wherein said input means comprises a voice recognition means whereby voice input to said first communication device effects a corresponding vibration of said second communication device.

15. The medium as set forth in claim 10 wherein at least one of said first and second communication devices comprises a wireless communication device.

16. The medium as set forth in claim 15 wherein said one of said first and second communication devices comprises a cell phone.

17. The medium as set forth in claim 15 wherein said one of said first and second communication devices comprises a personal digital assistant device.

18. The medium as set forth in claim 10 wherein said selected input is presented on a display screen of said first communication device.

19. A first communication device enabled to use tactile means of a second communication device to communicate information from a first party using said first communication device to a second party using said second communication device, said first communication device comprising:
a system bus;
a CPU device connected to said system bus;
memory means connected to said system bus;
a display device connected to said system bus; and
input means coupled to said system bus, said first communication device being selectively operable for establishing a telecommunication connection between said first communication device and said second communication device, said input means being arranged to enable said first party to selectively enter selected input to said first communication device after said establishing of said telecommunication connection, said first communication device being further operable for transmitting information signals representative of said selected input from said first communication device to said second communication device, said information signals being operable at said second communication device for commencing a vibration of said second communication device in response to said received information signals.

20. A method for selecting a telephone number comprising:
displaying a telephone directory with a plurality of directory entries;
selecting a first directory entry from said plurality of directory entries;
associating a first vibration pattern with said first directory entry; and
storing said first vibration pattern in association with said first directory entry.

21. The method as set forth in claim 20 and further including:
producing said first vibration pattern in response to a selection of said first directory entry.

22. A method for effecting a vibratory response at a second communication device in response to input to a first communication device, said method comprising:
establishing a telecommunication connection between said first communication device and said second communication devices;
providing input means by which selected input is applied at said first communication device after said establishing of said telecommunication connection; and
enabling said second communication device to commence a vibration of said second communication device in response to said selected input.

23. The method as set forth in claim 22 wherein said first communication device is an answering machine.

24. The method as set forth in claim 22 wherein said first communication device includes a voicemail system.

25. The method as set forth in claim 22 wherein said first communication device is capable of obtaining instant system status information.

26. The method as set forth in claim 25 wherein said selected input is comprised of said system status information.
